(19) United States
(12) Patent Application Publication
(10) Pub. No.: US 2005/0235427 A1
(43) Pub. Date: Oct. 27, 2005

(54) Multipurpose tool

(76) Inventors: Dale Brian Halling, Colorado Springs, CO (US); Kaila Geary Halling, Colorado Springs, CO (US); Warren Edward Roh, Littleton, CO (US); Eckehart Zimmerman, Monument, CO (US)

Correspondence Address: LAW OFFICE OF DALE B. HALLING, LLC, 655 SOUTHPOINTE COURT, SUITE 100, COLORADO SPRINGS, CO, 80906, US

(21) Appl. No.: 10/832,042

(22) Filed: Apr. 26, 2004

(51) Int. Cl. B25G 1/00

(52) U.S. Cl. 7/167

(57) ABSTRACT

A multipurpose tool has a curved handle. A first tool is incorporated in the curved handle and part of the curved handle. A working end is connected to the curved handle and has a second tool on an edge of the working end.

### FIELD OF THE INVENTION

The present invention relates generally to the field of tools and more particularly to a multipurpose tool.

### BACKGROUND OF THE INVENTION

Computers have become ubiquitous in our lives. When computer screens are dirty from dust or fingerprints, this increases the amount of eye strain that the user suffers. Presently, most users wipe their computer screens with a damp cloth or paper towel. While this is generally effective it is not convenient. Most users do not keep clean cloths around to clean their screens and the thin panel screens should ideally not be cleaned with paper towels. There are tools for cleaning computer screens that use a brush or bristles. As result, these tools are effective for dust but not effective for cleaning fingerprints and other grime. In addition, bristles may scratch flat panel displays.

Thus there exists a need for a tool that cleans computer screens of both dust and fingerprints.

### SUMMARY OF INVENTION

A multipurpose tool has a curved handle. A first tool is incorporated in the curved handle and part of the curved handle. A working end is connected to the curved handle and has a second tool on an edge of the working end. The second tool includes a soft pliable material. In one embodiment, the second tool is an ice scrapper. The curved handle is formed to fit a bottle.

In one embodiment, the first tool is a magnifying glass. In another embodiment, the first tool is a letter opener.

In one embodiment, a bottle is designed to be cupped by the curved handle. The first tool may be a bottle opener. A lid may attach over the handle.

In one embodiment a multipurpose tool has a handle. A magnifying glass is incorporated into the handle. A working end is attached to the handle and has a pliable material attached to the working end. A letter opener may be formed in the handle. An LED may be attached to the handle. An Emory board may be placed along the handle. In one embodiment, the handle is a curved surface and has a concave side and a convex side. The concave side is shaped to fit a bottle.

A promotional item has a curved handle. A letter opener is incorporated into the curved handle. An edge extends from the handle and has a cleaning material attached to the edge. Printing may be placed on the curved handle. A bottle may be designed to be cupped by the curved handle. In one embodiment, a magnifying glass is incorporated into the curved handle. A printed material may be placed on the bottle so that it aligns with the magnifying glass.

### BRIEF DESCRIPTION OF THE DRAWINGS

FIG. 1 is a top left perspective view of a multipurpose tool in accordance with one embodiment of the invention;

FIG. 2 is a bottom left perspective view of a multipurpose tool in accordance with one embodiment of the invention;

FIG. 3 is an exploded view of a multipurpose tool in accordance with one embodiment of the invention;

FIG. 4 is a top left perspective view of a multipurpose tool in accordance with one embodiment of the invention;

FIG. 5 is a bottom left perspective view of a multipurpose tool in accordance with one embodiment of the invention; and

FIG. 6 is a top left perspective view of a multipurpose tool in accordance with one embodiment of the invention.

### DETAILED DESCRIPTION OF THE DRAWINQS

The multipurpose tool combines a number of functions that an office worked needs, such as a screen cleaner a magnifying glass, a letter opener and other functions. FIG. 1 is a top left perspective view of a multipurpose tool 10 in accordance with one embodiment of the invention. The tool 10 has a handle 12 and a working end 14. A magnifying glass 16 or first tool is incorporated into the handle 12 of the tool 10. In one embodiment, the magnifying glass 16 is replaced with a bottle opener. In another embodiment, the magnifier 16 is formed into the handle of the tool. This is done by forming the tool out of a clear plastic, such as a poly carbonate. Also incorporated into the handle 12 is a letter opener 18 or other first tool. At the working end 14, is an edge 20 to which is attached a second tool 22 such as soft pliable material or cleaner tool. In one embodiment, the soft pliable material is felt, micro-fiber material, cloth, leather or possibly foam or rubber. This tool can be used to clean computer screens, windshields, television screen, etc.

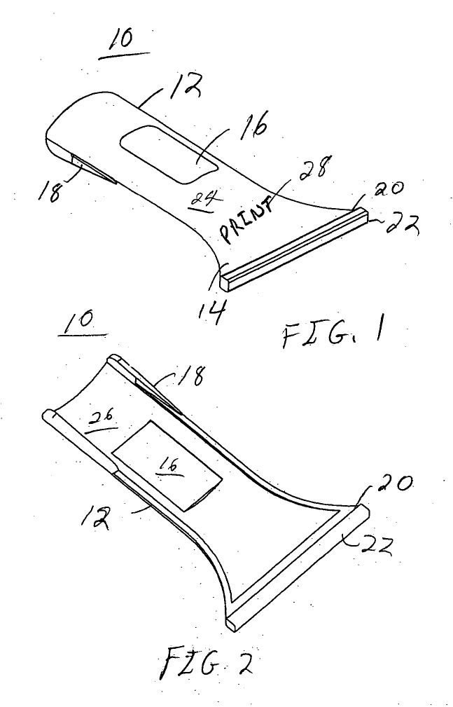

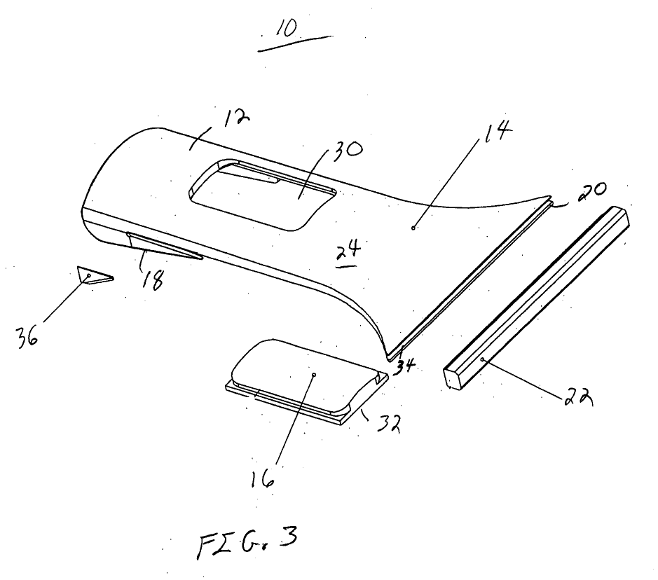

The handle 12, in one embodiment, is a curved handle and has a convex side 24 and concave side 26. FIG. 2 is a bottom left perspective view of a multipurpose tool 10 in accordance with one embodiment of the invention. FIG. 2 shows the concave side 26 of the tool 10. In one embodiment, the tool 10 may be used as a promotional item. In this case printed matter 28 may be placed on the handle 12 or other portion of the tool 10.

FIG. 3 is an exploded view of a multipurpose tool 10 in accordance with one embodiment of the invention. The tool 10 has a main body consisting of a handle 12 and a working end 14. A cavity 30 in the handle 12 is filled by a magnifying glass 16. In one embodiment, the magnifying glass 16 is made of plastic and snaps into the cavity 30. In one embodiment, a lower surface 32 of the magnifying glass 16 substantially conforms to the concave surface 26 (See FIG. 2) of the handle 12. In yet another embodiment, the handle 12 is formed of a clear plastic and the magnifier 16 is formed into the handle 12. A tool 22 is attached to an edge 20 of the working end 14. In one embodiment, the tool 22 is a soft pliable material that may be used to clean computer screens. In another embodiment, the tool may be a squeegee, a scrapper, a knife, etc. The tool 22, in one embodiment, slides into a groove 34 of the working edge 20. In another embodiment, the tool 22 is adhered to the edge 20. A letter opener 18 includes a blade 36. The blade 36 may be formed of metal. In another embodiment, the letter opener does not includes a blade and is formed in the handle 12. In one embodiment, the letter opener 18 is replaced with a seat belt cutter. The seat belt cutter has essentially the same basic construction as a letter opener, but the dimensions are adjusted for this alternative purpose.

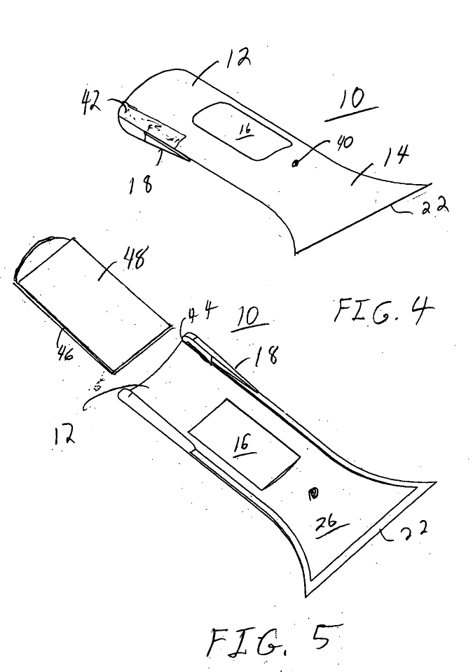

FIG. 4 is a top left perspective view of a multipurpose tool 10 in accordance with one embodiment of the invention. In this embodiment of the multipurpose tool 10 the tool 22 is a scrapper, such as an ice scrapper. In addition, this embodiment includes a LED light 40. The LED 40 may point down or shine away from the concave surface 26 of the handle 12. This allows the LED 40 to provide illumination for the magnifier 16. The LED 40 is powered by a small battery (not shown). The battery may fit inside the handle or may fit in a slot on the concave surface 26 of the handle 12. The tool 12 shown in FIG. 4 also contains an Emory board 42. The Emory board 42 may be attached with glue.

FIG. 5 is a bottom left perspective view of a multipurpose tool 10 in accordance with one embodiment of the invention. In this embodiment of the tool 10 a groove 44 is provided for a cover or lid 48 to fit over the concave surface 26. The lid 48 has a lip 46 that engages the groove 44. As a result, a pocket is formed that may be used to hold items such as a needle, pencil, matches, etc.

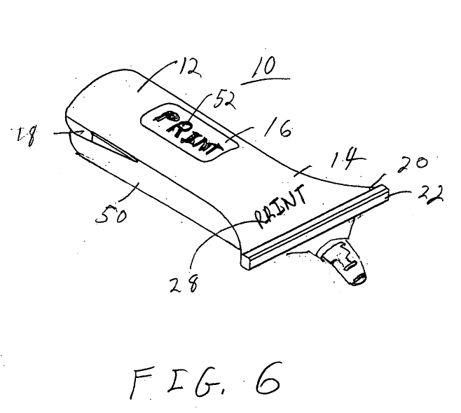

FIG. 6 is a top left perspective view of a multipurpose tool 10 in accordance with one embodiment of the invention. In this embodiment, the tool 10 is shown with a bottle 50. Note that the bottle's surface essentially matches the concave 26 surface of the handle 12. The bottle 50 may include printed matter 52 that aligns with the magnifier 16.

Thus there has been described a multipurpose tool that provides many of the functions required by an office worker in one useful and compact package. In addition, the tool may have a soft pliable material tool that cleans computer screens of dust, grime and fingerprints.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

1. A multipurpose tool, comprising:
a curved handle;
a first tool incorporated in the curved handle and part of the curved handle; and
a working end connected to the curved handle and having a second tool on an edge of the working end.

2. The multipurpose tool of claim 1, wherein the second tool includes a soft pliable material.

3. The multipurpose tool of claim 1, wherein the second tool is an ice scrapper.

4. The multipurpose tool of claim 1, wherein the curved handle is formed to fit a bottle.

5. The multipurpose tool of claim 4, wherein the first tool is a magnifying glass.

6. The multipurpose tool of claim 2, wherein the first tool is a letter opener.

7. The multipurpose tool of claim 1, further including a bottle designed to be cupped by the curved handle.

8. The multipurpose tool of claim 3, wherein the first tool is a bottle opener.

9. The multipurpose tool of claim 1, further including a lid that attaches over the handle.

10. A multipurpose tool, comprising:
a handle;
a magnifying glass incorporated into the handle; and
a working end attached to the handle having a pliable material attached to the working end.

11. The multipurpose tool of claim 10, further including a letter opener formed in the handle.

12. The multipurpose tool of claim 10, further including an LED attached to the handle.

13. The multipurpose tool of claim 11, further including an Emory board along the handle.

14. The multipurpose tool of claim 10, wherein the handle is a curved surface having a concave side and a convex side.

15. The multipurpose tool of claim 14, wherein the concave side is shaped to fit a bottle.

16. A promotional item, comprising:
a curved handle;
a letter opener incorporated into the curved handle; and
an edge extending from the handle having a cleaning material attached to the edge.

17. The promotional item of claim 16 having printing on the curved handle.

18. The promotional item of claim 16, further including a bottle designed to be cupped by the curved handle.

19. The promotional item of claim 18, further including a magnifying glass incorporated into the curved handle.

20. The promotional item of claim 18, wherein a printed material is placed on the bottle so that it aligns with the magnifying glass.
